(19) United States
(12) Patent Application Publication
(10) Pub. No.: US 2005/0129820 A1
(43) Pub. Date: Jun. 16, 2005

(54) Composition comprising vegetables of the genus Capsicum and process for preparing the same

(75) Inventors: Rudi Gunter Muller, Heilbronn (DE); Jacqueline Sabine Steinert, Heilbronn (DE)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Unilever Bestfoods North America, Division of Conopco, Inc.

(21) Appl. No.: 11/011,293

(22) Filed: Dec. 14, 2004

(30) Foreign Application Priority Data
Dec. 16, 2003 (EP) 03079090.1

(51) Int. Cl. A23L 1/00

(52) U.S. Cl. 426/518

(57) ABSTRACT

An edible composition comprising vegetables of the genus Capsicum having a good taste and considerable vitamin C content, and the process for preparing the same. The process comprising the steps of: (a) comminuting the vegetables, (b) subjecting the comminuted vegetables to an enzyme treatment with a pectinase enzyme preparation, (c) concentrating the enzyme-treated comminuted vegetables, wherein the vegetables are subjected to a dry heat treatment at a temperature of at least about 80° C. prior to, during, or after said comminuting step.

### FIELD OF THE INVENTION

The present invention relates to an edible composition comprising vegetables of the genus Capsicum, and in particular to compositions which should have a good taste and considerable vitamin C content, and the process for preparing the same.

### BACKGROUND OF THE INVENTION

There is a current trend among consumers for healthier, good tasting food, in particular in the developed world. Preferably, such food compositions should contain a considerable amount of vegetables and/or fruit and/or a high content of healthy components (vitamins, anti-oxidants, etcetera) from such fruit/vegetables.

It is known that vegetables of the genus Capsicum contain a considerable amount of healthy components (vitamins, antioxidants, etcetera). Examples of vegetables of the genus Capsicum are peppers, sweet pepper, bell pepper (e.g. red, yellow, green and black), Turkish elongated peppers, etcetera. For some applications, such vegetables may be too bulky for further processing into food, or for application into dry products.

The Derwent abstract of KR 8905256 discloses a process for the preparation of a red pepper paste, which process comprises:
scalding raw red pepper in boiling water (85-100° C.) for 4-8 minutes and cooling
cutting and mixing
adding cell-collapsing enzyme preparation composed of pectinase, cellulase and hemicellulase etcetera produced by Aspergillus niger and incubate
remove the skin of the above-treated red pepper by pulp finisher
heating to 90-100° C. for 1-5 minutes
concentrate by ordinary method.

U.S. Pat. No. 3,615,721 discloses treating vegetable and fruit material with enzymes having cellulase, hemi-cellulase and pectinase activity, mechanically treating the material to form a slurry or paste, followed by shaping and drying the material.

Thus, there is a need for a process for obtaining edible compositions which comprise vegetables of the genus Capsicum in a concentrated form. Preferably, such composition should be rich in vitamins (in particular vitamin C) and/or antioxidants and have a good taste.

Regarding the latter, it was found that many existing concentrates of the vegetable of the genus Capsicum have a fermented and/or bitter off-taste.

Regarding the level of vitamins and/or antioxidants, it was found that the level of vitamin C in the concentrate of vegetables of the genus Capsicum can be a yardstick or indicator for the level of other goodies: if the amount of vitamin C in such products is considerable, the amount of other vitamins and/or antioxidants is also considerable. This is not an absolute and quantitative correlation, but it is an indicator, and as vitamin C levels are fairly easy to measure, but levels of other vitamins and/or antioxidants are not, the amount of vitamin C in a preparation comprising concentrated vegetables of the genus Capsicum is a practical indication on the total amount of vitamins and/or antioxidants maintained after processing the vegetable, when compared to fresh. This is important, as certain steps in processing and concentrating vegetables of the genus Capsicum may have a negative impact on vitamin and/or antioxidant levels.

### SUMMARY OF THE INVENTION

It has now been found that the above objectives can be met at least in part by a process for preparing a composition comprising vegetables from the genus of Capsicum, which process comprises the steps of:
(a) comminuting the vegetables,
(b) subjecting the comminuted vegetables to an enzyme treatment with a pectinase enzyme preparation,
(c) concentrating the enzyme-treated comminuted vegetables,
   wherein the vegetables are subjected to a dry heat treatment at a temperature of at least about 80° C. prior to, during, or after said comminuting step.

In the above, it was found that the fermented off-taste found by prior art processes was reduced to a large extent when prior to the enzyme treatment the vegetables, comminuted or not, are subjected to a dry heat treatment of at least about 80° C. Surprisingly, it was also found that such dry heat treatment can lead to an enhanced level of vitamin C in the resulting product. Such dry heat treatment can be achieved e.g. contact-, convection- or irradiation heating, or combinations thereof. Such can be achieved by means as known in the art of food processing, e.g. by roasting or grilling. Preferably said dry heat treatment is at a temperature of at least about 120° C., more preferably at least about 150° C., and suitably at temperatures below about 250° C., e.g. about 150-250° C., or about 200-250° C. Said dry heat treatment can be applied on the whole, uncomminuted vegetables, or on the comminuted vegetables, or during communition.

Enzymes are usually offered as “cocktails” of several activities rather than a single enzymatic activity. However, in many cases the different enzyme activities can still act on the same composition, as the composition can have a complex chemical structure having various types of chemical bounds, requiring different enzyme activities for break down. An example of this is enzyme cocktails as offered as “pectinase”. Such pectinase composition often contains one or more of the following activities: polygalacturonase, pectin lysase, pectin methyl esterase. Pectinase preparations are often used in fruit juice processing. It is preferred in the present invention that the enzyme preparation used contains at least one of these three activities mentioned, preferably two, more preferably all three.

Although polygalacturonase is the common name, the systematic name is poly(1,4-α-D-galacturonide glycanohydrolase. The reaction it is active on is random hydrolysis of 1,4-α-D-galactosiduronic linkages in pectate and other galacturonans. Other names used for such enzyme activity are (pectin) endopolygalacturonase, pectin galacturonase, endo-polygalacturonase, poly-α-1,4-galacturonide glycanohydrolase, endogalacturonase, or endo-D-galacturonase.

### DETAILED DESCRIPTION OF THE INVENTION

In the above process, it is preferred that the enzyme treatment is effected for about 10 minutes-about 24 hours, preferably for about 30 minutes-about 2 hours. A suitable temperature for effecting the enzyme treatment of the comminuted vegetables is about 20-75° C., preferably about 40-60° C. After the enzyme treatment the enzyme is preferably inactivated, e.g. by subjecting to a temperature high enough, e.g. by heating to at least about 75° C., preferably at least about 80° C. for at least about 1 minute.

In the process according to the invention the enzyme treatment is preferably done on finely comminuted vegetable matter, preferably the comminution is such that the matter is in the form of a puree.

The concentration of the enzyme-treated matter is preferably carried out to such an extent to yield a product (e.g. concentrate or puree) of at least about 15° Brix, preferably at least about 20° Brix or even above about 40° Brix (the latter more typical for puree). The concentration itself can be carried out by conventional means. Optionally, the concentration may involve drying of the product to yield a dry bell pepper matter. The drying can be carried out by techniques known in the art, usually involving a carrier material (e.g. about 10-90% wt based on the final composition), e.g. maltodextrin.

In yet a further improvement of the process according to the invention the process further comprising a step for removing the peel of the vegetables, in particular of the vegetables of the genus Capsicum. This can be particularly well achieved if the vegetables are roasted. In case of a puree preparation the peel can be separated by a sieving equipment, for the juice processing a classical solid liquid separation can be conducted (decanter or filter press) to remove the peel.

It is preferred in the present invention that the vegetables subjected to the process as set out comprise at least about 50% fresh weight, preferably at least about 70% fresh weight, most preferably about 100% fresh weight of vegetables of the genus Capsicum. In case of lower than about 100% Capsicum, other vegetables that may be present (i.e. about 50% wt or less, preferably about 30% wt or less) are aubergines, courgettes, tomatoes, carrot, onion. These vegetables may be applied as fresh or frozen and are preferably pretreated by a dry heat treatment. Preferred vegetables of the genus Capsicum in the present process are bell pepper, and more in particular the red, orange or yellow versions.

The vitamin C level of fresh red bell pepper is about 140 mg/100 g fresh weight. The antioxidative activity is about 12 mmol/l (at 7° Brix). This level is amongst the highest found for vegetables. The antioxidative activity is measured by the so called TEAC (Trolox Equivalent Antioxidant Capacity). Commercial bell pepper preparations (canned) have a vitamin C content of about 0-5 mg/100 g fresh weight and the antioxidative activity was found to be about 3 mmol/l. A frozen commercial red bell pepper sample has a vitamin C content of about 34 mg/100 g fresh weight and a TEAC of about 6 mmol/l. A bell pepper which is blanched, and then treated enzyme as in the present invention has a vitamin C content of about 90 mg/100 g fresh weight. It was found that with the process according to the invention the bell pepper which is roasted/grilled at about 200° C. (i.e. subjected to dry heat), and enzyme treatment according to the invention has about 130 mg/100 g fresh weight vitamin C. In such calculations, the amount of vitamin C is calculated on the basis of the fresh weight of the bell pepper that was used, and thus is largely independent of the concentration step. If the bell pepper composition prepared as above (grilled, about 200° C.) is dried (e.g. under vacuum) with a (carbohydrate) carrier (percentage of the carrier in dried product is about 35% wt) the vitamin C content is about 350 mg/100 g product.

Thus, the invention also relates to a composition not being dry of processed vegetables of the genus Capsicum, the composition having a vitamin C content of about 100-500 (preferably about 100-400) mg per 100 g as calculated on the fresh bell pepper. Preferably such composition is pasteurised or sterilised, and storage stable. Preferably it has a TEAC of at least about 8 mmol/l, more preferably at least about 9 mmol/l.

The invention further relates to a composition (in the form of powder or particulates) of dry vegetables of the genus Capsicum having a vitamin C content of about 100-1000 mg (preferably about 200-700)/100 g dry powder weight.

In the above, the vegetables of the genus Capsicum are preferably bell pepper, and preferably the red, orange or yellow colored ones.

### EXAMPLES

### Example 1a

### Concentrate and Dried Product, Fresh Bell Pepper

Fresh red bell pepper was cleaned and halved and subjected to convection heating for 20 minutes, 220° C. Thereafter, the skin was peeled, and the resulting peeled halves were pureed in a cutter. The bell pepper puree was subjected to enzymatic maceration with 1 mg/kg Fructozyme (Erbsloeh) enzyme preparation (pectinase, arabinase, cellulase and hemicellulase activity) for 2 hours and 47° C. The macerated preparation was pressed to a juice and the enzyme activity was inactivated by briefly heating to 80° C. for 2 minutes. This concentrate contained about 125 mg vitamin C per 100 g fresh weight. The juice yield prior to concentration was about 85%, with excellent taste.

The juice was concentrated by evaporation to about 66° Brix. A vitamin C content of about 570 mg/100 g product could be measured in this preparation.

The concentrate was dried under vacuum with maltodextrin as carrier (carrier content in final product: 35% wt). The vitamin C content of the dry powder was 350 mg/100 g.

### Examples 1b-e

### Concentrate, Fresh Bell Pepper

The procedure as above, except for the concentration and drying steps, was repeated with bell peppers subjected to different heating steps, and the juice yield, taste and vitamin C content was determined. The results are set out in the table below. Fresh bell pepper contained about 137 mg/100 g fresh weight vitamin C.

| | | | Vitamin C mg/100 g |
|---|---|---|---|
| Heating procedure | Juice yield (%) | Sensory | fresh weight |
| b: Flash heating (1 min./90° C.) | 62 | Cooked taste but | 63 |
| | | no off-flavour | |
| c: Steam pressure | 58 | Cooked taste but | 58 |
| (5 min./112° C.) | | no off-flavour | |
| d: Blanching (5 min./90° C.) | 53 | Cooked taste but | 90 |
| | | no off-flavour | |
| e: Grill (20 min./220° C.) | 85 | Slightly roasted | 125 |
| | | taste, no cooked | |
| | | or fermented off- | |
| | | taste | |

### Example 2

### Puree and Dried Product, Frozen Grilled Bell Pepper

The puree was made of commercially available defrosted, pretreated grilled red bell pepper pieces which were cut and homogenised with a blender. Then enzymes 1 mg/kg Rohament PL (Ab Enzymes) and 1 mg/kg Fructozyme Citrus cloudy (Erbsloeh) were added both into the sludge using a water quench. The reaction time was 2 hours. Before inactivation of enzymes (80° C., 2 min) the sample was pureed through a sieve (mash 0.5 mm). The vitamin C content of the puree was 107 mg/100 g fresh weight and the antioxidative activity is approx. 12 mmol/l. The taste of the puree was good.

The puree as obtained above was concentrated under vacuum to 30° Brix (vitamin C content about 250 mg mg/100 g product). The taste of this concentrated puree was also good.

The puree concentrate was dried by vacuum drying on maltodextrin as carrier (maltodextrin content in endproduct: about 35% wt). The vitamin C content of the dry powder was about 175 mg/100 g dried product.

1. Process for preparing a composition comprising vegetables from the genus of Capsicum, which process comprises the steps of
(a) comminuting the vegetables,
(b) subjecting the comminuted vegetables to an enzyme treatment with a pectinase enzyme preparation,
(c) concentrating the enzyme-treated comminuted vegetables,
wherein the vegetables are subjected to a dry heat treatment at a temperature of at least about 80° C. prior to, during, or after said comminuting step.

2. Process according to claim 1, wherein the dry heat treatment is achieved by contact-, convection- or irradiation heating or combinations thereof.

3. Process according to claim 1, wherein the dry heat treatment comprises roasting and/or grilling.

4. Process according to claim 1, wherein said dry heat treatment is at a temperature of at least about 120° C., more preferably at least about 150° C.

5. Process according to claim 1, wherein the pectinase enzyme preparation comprises one or more of the following activities: polygalacturonase, pectin lysase, pectin methyl esterase.

6. Process according to claim 1, wherein the enzyme treatment is effected for about 10 minutes-about 24 hours.

7. Process according to claim 1, wherein the temperature of the comminuted vegetables when subjected to the enzyme treatment is about 20-75° C.

8. Process according to claim 1, further comprising an inactivation of the enzyme by h eating to at least about 75° C., preferably at least about 80° C. for at least about 1 minute.

9. Process according to claim 1, wherein the comminution in step (a) is such that it leads to a puree.

10. Process according to claim 1, wherein the concentration is carried out to yield a product of at least about 15° Brix, preferably at least about 20° Brix.

11. Process according to claim 1, wherein the concentration involves drying of the product.

12. Process according to claim 1, wherein the vegetables of the genus Capsicum are fresh vegetables.

13. Process according to claim 1, further comprising a step for removing the peel of the vegetables.

14. Process according to claim 1, wherein the vegetables of the genus Capsicum comprises bell pepper.

15. Composition of processed vegetables of the genus Capsicum having a vitamin C content of about 100-500 (preferably about 100-400) mg per 100 g as calculated on the weight of fresh vegetables of the genus Capsicum.

16. Composition according to claim 15, which is pasteurised or sterilised.

17. Powder or particulates of dry vegetables of the genus Capsicum having a vitamin C content of about 100-1000 mg (preferably about 200-700)/100 g dry powder weight.

18. Composition as claim 15, wherein the vegetables of the genus Capsicum is bell pepper.
